(19) United States
(12) Patent Application Publication
(10) Pub. No.: US 2026/0070104 A1
(43) Pub. Date: Mar. 12, 2026

(54) Method For The Degradation Of Microplastics in Soil

(71) Applicant: Beijing Normal University, Beijing (CN)

(72) Inventors: Fei WANG, Beijing (CN); Junhong LI, Beijing (CN); Shuai MA, Beijing (CN); Manman CAO, Beijing (CN); Na XIAO, Beijing (CN)

(73) Assignee: Beijing Normal University, Beijing (CN)

(21) Appl. No.: 19/393,497

(22) Filed: Nov. 18, 2025

(30) Foreign Application Priority Data
Mar. 24, 2025 (CN) 202510347475.6

(51) Int. Cl. B09C 1/10

(52) U.S. Cl. CPC B09C 1/10

(57) ABSTRACT

The present disclosure belongs to the field of soil pollution remediation, and specifically provides a degradation method for microplastics in soil. A technical solution is provided, utilizing an interaction between natural iron minerals and microplastics, mediated by soil microorganisms, and using free radicals generated in hydrated iron to accelerate aging of the microplastics, thereby effectively promoting degradation of the microplastics and enhancing the environmental friendliness and degradability of the microplastics.

### TECHNICAL FIELD

The present disclosure belongs to the field of soil pollution remediation, and specifically relates to a degradation method for microplastics in soil.

### BACKGROUND

Microplastics (MPs), as emerging pollutants, are widely distributed in water, soil, and sediments. A long-term ecological risk resulting from the difficulty in degrading the MPs is one of the environmental issues that have received widespread attention in recent years. Degradation of the MPs has always been a research focus in the field of environmental science. Especially under the mediation of natural minerals such as ferrihydrite, an interaction between the MPs and the minerals have been found to potentially affect the migration, degradation, and stability of the MPs.

Ferrihydrite is a weakly crystalline iron mineral and is also widely present in water, soil, and sediments. As a primary phosphorus sink, and due to a large specific surface area and adsorption capacity, the ferrihydrite adsorbs phosphorus, thereby limiting the bioavailability of the phosphorus and affecting functions of microorganisms. In addition, besides phosphorus, the ferrihydrite also commonly combines with organic carbon, preventing further mineralization of the organic carbon by combining with the organic carbon. MPs are considered a hidden carbon source and a storage reservoir, and surface functional groups of the MPs act as “electron shuttles”, attracting microorganisms to use the MPs as electron acceptors or donors during metabolic processes. In an aquatic environment, an interaction between the MPs and ferrihydrite significantly affects the migration and fate of the MPs. During a formation process of ferrihydrite flocs, polyethylene plastic can be rapidly incorporated and buried. A combination of the MPs with the flocs or aggregates changes the fate and bioavailability of the MPs. However, there are few reports related to the environmental behavior and fate of the MPs encapsulated by the ferrihydrite in an environment.

### SUMMARY

To solve the foregoing problems, the present disclosure provides a degradation method for microplastics in soil, comprising the following steps:
(1) extracting soil microorganisms: mixing sterile water with soil at a ratio of 2.5:1, mixing on a shaker, and standing to obtain a supernatant containing the soil microorganisms;
(2) synthesizing ferrihydrite co-precipitated with polylactic acid microplastics (PLA MPs): dissolving 40 g of Fe(NO3)3·9H2O in 500 mL of deionized water; adding 4 g of PLA MPs, and then adding 310 mL of 1 M KOH to adjust a pH; vigorously stirring for 1 hour using a magnetic stirrer, and then performing centrifugation; after discarding a supernatant, repeatedly washing an obtained colloid 5 times with the deionized water; drying the colloid in a freeze dryer for 24 h, and storing the colloid at −20° C. for later use;
(3) performing phosphorus adhesion on the ferrihydrite: adding 1.2 g of the ferrihydrite to 500 mL of 20 mM K2HPO4, adjusting a pH to 6, incubating for 48 hours, and then freeze-drying to obtain a product; and
(4) culturing the ferrihydrite co-precipitated with PLA MPs after the phosphorus adhesion in the supernatant containing the soil microorganisms to degrade microplastic particles.

Further, mixing conditions on the shaker in step (1) are 150 rpm and 30 min.

Further, a standing time in step (1) is 6 h.

Further, centrifugation conditions in step (2) are 12000 rpm and 12 minutes.

Further, a range of the pH adjustment in step (2) is pH 7.4-7.6.

Further, incubation conditions in step (3) are 28° C. and 150 r/min.

Further, culture conditions in step (4) are 28° C., 150 rpm, and culturing for 30 days.

Further, the culture conditions in step (4) comprise incubation in the dark.

The present disclosure has the following beneficial effects:

The present disclosure, by proposing an interaction between ferrihydrite and microplastics mediated by soil microorganisms, shows that encapsulation of the microplastics by the ferrihydrite, in particular, further accelerates aging of the microplastics and produces less carbon dioxide than a direct interaction between the microplastics and the ferrihydrite. Thereby, problems of the microplastics in the environment being difficult to degrade and the production of carbon dioxide affecting the climate are effectively solved, and the present disclosure has high environmental adaptability and practical application potential.

### BRIEF DESCRIPTION OF DRAWINGS

To more clearly illustrate the technical solutions in the embodiments of the present disclosure or in the prior art, the following is a brief introduction to the drawings required for use in the embodiments. The drawings in the following description are evidently merely some embodiments of the present disclosure, and for a person of ordinary skill in the art, other drawings can also be obtained based on the drawings without inventive effort.

FIG. 1 is an SEM images of microplastics before and after aging;

FIG. 2 shows XRD and FTIR of microplastics before and after aging;

FIG. 3 shows an SEM images and a specific surface area of ferrihydrite;

FIG. 4 is an SEM-EDS characterization of ferrihydrite after phosphorus adsorption;

FIG. 5 is an SEM-EDS characterization of microplastics of a co-precipitation group after phosphorus adsorption;

FIG. 6 is an FTIR spectrum of microplastics after incubation;

FIG. 7 shows a change in a carbonyl index of microplastics after incubation;

FIG. 8 shows the synchronous and asynchronous 2D correlation maps of microplastics after incubation;

FIG. 9 shows carbon dioxide gas concentrations of each group; and

FIG. 10 is a stacked diagram of absolute quantification of different functional genes of microorganisms of each group.

### DETAILED DESCRIPTION

Multiple exemplary embodiments of the present disclosure are now described in detail. Unless otherwise specified, methods in the embodiments all adopt conventional methods, and unless otherwise specified, reagents used are all conventional commercially available reagents or reagents prepared by conventional methods. The detailed description should not be considered as a limitation to the present disclosure, but should be understood as a more detailed description of certain aspects, features, and implementations of the present disclosure.

The terms described in the present disclosure should be understood to be merely for describing particular embodiments, and not for limiting the present disclosure. In addition, for the numerical ranges in the present disclosure, each intermediate value between the upper limit and the lower limit of the range should be understood to be also specifically disclosed. Each smaller range between any stated value or intermediate value within a stated range, and any other stated value or intermediate value within the stated range is also included in the present disclosure. The upper and lower limits of these smaller ranges may be independently included or excluded from the range.

Unless otherwise specified, all technical and scientific terms used herein have the same meaning as commonly understood by a person of ordinary skill in the art to which the present disclosure belongs. Although the present disclosure only describes methods and materials, any methods and materials similar or equivalent to those described herein can also be used in the practice or testing of the present disclosure. All documents mentioned in the present specification are incorporated by reference to disclose and describe the methods and/or materials related to the documents. In case of conflict with any incorporated documents, the content of the present specification shall prevail.

Various improvements and variations can be made to the specific embodiments of the specification of the present disclosure without departing from the scope or spirit of the present disclosure, which will be apparent to a person skilled in the art. Other embodiments derived from the specification of the present disclosure will be apparent to a person skilled in the art. The specification and the embodiments of the present disclosure are exemplary only.

Regarding “comprising”, “including”, “having”, “containing”, and the like used herein, all are open-ended terms, that is, meaning including but not limited to.

### 1. Extraction of Soil Microorganisms

Sterile water and soil are mixed at a ratio of 2.5:1, mixed on a shaker at 150 rpm for 30 min, and after standing for 6 hours, a supernatant (SE) containing the soil microorganisms is obtained. The soil is collected from Fujian, China, and is naturally air-dried, crushed, and filtered through a 2 mm soil sieve.

### 2. Aging of Polylactic Acid Microplastics

Since microplastics in the environment are usually aged microplastics, microplastics combined with laboratory chemical aging and photo-aging are used in the present method. The specific method is as follows: 100 g of PLA MPs are added to a 1 L glass beaker, and then immersed in 500 mL of a 10% (mass fraction) hydrogen peroxide solution. Subsequently, the beaker is placed in a photochemical reactor (BILON, Shanghai, BL-GHX-V), the reactor is equipped with an ultraviolet mercury lamp (Light/dark=12/12 h, 500 W, 120 r/min), and an aging time is 7 d. During this period, hydrogen peroxide is supplemented every morning and evening. After the aging is completed, the PLA MPs are washed three times with deionized water and then dried at 40° C. The crystal structures of the pristine and aged PLA MPs are characterized by a scanning electron microscope (SEM), X-ray diffraction (XRD), and a Fourier transform infrared spectrometer (FTIR).

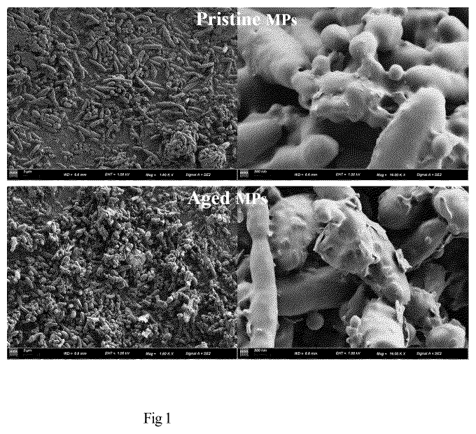

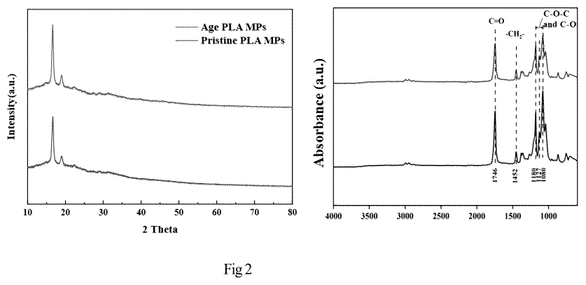

As shown in FIG. 1 and FIG. 2, compared with the pristine microplastics, the surface fragmentation of the aged microplastics increased, while the crystallinity decreased, and the peak intensity of functional groups was reduced. The results indicate that the functional groups in the amorphous region on the surface of the microplastics are degraded after aging.

### 3. Synthesis of Ferrihydrite and Phosphorus Adsorption:

Pure ferrihydrite (Fh) and phosphorus-containing ferrihydrite were synthesized using the method of Darcy et al., Briefly, 40 g of Fe(NO3)3·9H2O is first dissolved in 500 mL of deionized water. 310 mL of 1 M KOH is added for titration to a pH of 7.4-7.6. A mixture is vigorously stirred for 1 hour using a magnetic stirrer, and then centrifuged at 12000 rpm for 12 minutes. After discarding a supernatant, an obtained colloid is repeatedly washed 5 times with deionized water. The precipitate is dried in a freeze dryer for 24 h and stored at −20° C. for later use. In addition, ferrihydrite co-precipitated with PLA MPs (Fh-MP) is synthesized by additionally adding 4 g of polylactic acid microplastics (PLA MPs) (in a shape of spheres with a diameter of 2 mm, purchased from Dongguan Huakong Plastic Co., Ltd., China) after adding the Fe(NO3)3·9H2O during a synthesis process of the ferrihydrite. In addition, the phosphorus adsorption of the ferrihydrite is obtained by adding 1.2 g of the ferrihydrite to 500 mL of 20 mM K2HPO4 (with a pH adjusted to 6), incubating for 48 hours (28° C., 150 r/min), and then freeze-drying. The ferrihydrite after adsorbing phosphorus is characterized for surface morphology, specific surface area, and the distribution of adsorbed phosphorus using scanning electron microscope (SEM), the Brunauer-Emmett-Teller method (BET method), and scanning electron microscope-energy dispersive spectroscopy (SEM-EDS).

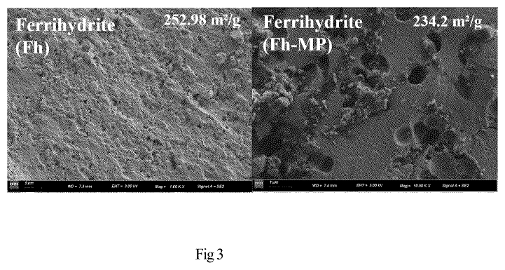

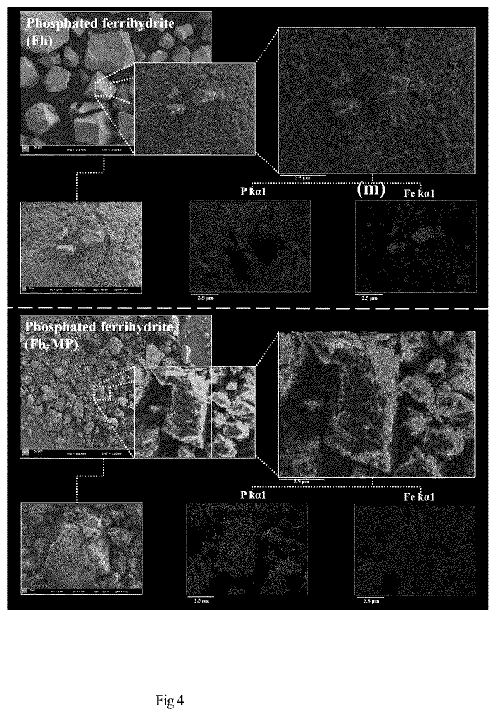

As shown in FIG. 3, the ferrihydrite formed by co-precipitation (Fh-MP) has a larger pore size and a smaller specific surface area than the pure ferrihydrite (Fh), and a lower phosphorus adsorption capacity (0.97 mM P/g and 1.17 mM P/g, respectively). FIG. 4 SEM-EDS shows that both surfaces of the two types of ferrihydrite have successfully adsorbed phosphorus.

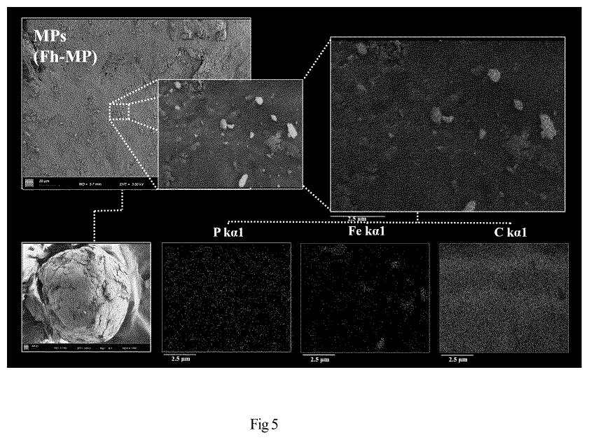

As shown in FIG. 5, after the co-precipitation, the surface of the microplastics is encapsulated by the ferrihydrite in a scale-like form, the encapsulating ferrihydrite has also adsorbed phosphorus, and the phosphorus is distributed relatively uniformly on the surface of the microplastics at a micrometer scale. During a process of co-precipitation of the ferrihydrite and the microplastics, the functional groups are encapsulated by the ferrihydrite. Such direct contact may enhance a redox reaction of iron, promoting a release of phosphorus and a degradation of the microplastics.

### 4. Soil Microorganism-Mediated Ferrihydrite Accelerating Microplastic Degradation

Soil microorganisms, ferrihydrite, and microplastics are added according to Table 1, and two groups without microorganisms are used for comparison. All groups are cultured for 30 days at 28° C., 150 rpm, and in the dark.

TABLE 1
Composition of each group

| | Concentration | | | |
|---|---|---|---|---|
| | of phosphorus- | | | |
| | containing | Concentration | | |
| Group | ferrihydrite | of PLA MPs | Type of | Solution |
| Name | (g/L) | (mg/L) | ferrihydrite | Composition |
| SE + | 1 | 100 | pure | supernatant |
| Fh + MP | | | ferrihydrite | containing |
| | | | | soil micro- |
| | | | | organisms |
| SE + | 1 | 100 | ferrihydrite | supernatant |
| Fh − MP | | | co- | containing |
| | | | precipitated | soil micro- |
| | | | with PLA | organisms |
| | | | MPs | |
| Fh + MP | 1 | 100 | pure | sterile water |
| | | | ferrihydrite | |
| Fh − MP | 1 | 100 | ferrihydrite | sterile water |
| | | | co- | |
| | | | precipitated | |
| | | | with PLA | |
| | | | MPs | |

5. Characterization of Microplastic Degradation after Incubation

After a 30-day incubation period is completed, the microplastics are separated, washed clean with deionized water, and naturally air-dried. The crystal structures of the original and aged PLA MPs are characterized using a Fourier transform infrared spectrometer (FTIR), and a change in a carbonyl index of the microplastics is analyzed in combination with the FTIR. The carbonyl index is usually used to quantify a degradation situation of functional groups of microplastics. A calculation method for the carbonyl index of the polylactic acid microplastics is a ratio of FTIR absorbance at a wavelength of 1746 cm 1 and 1452 cm 1. In addition, a change order of the functional groups of the microplastics of different groups is analyzed based on the FTIR results in combination with two-dimensional correlation spectroscopy (2D-COS).

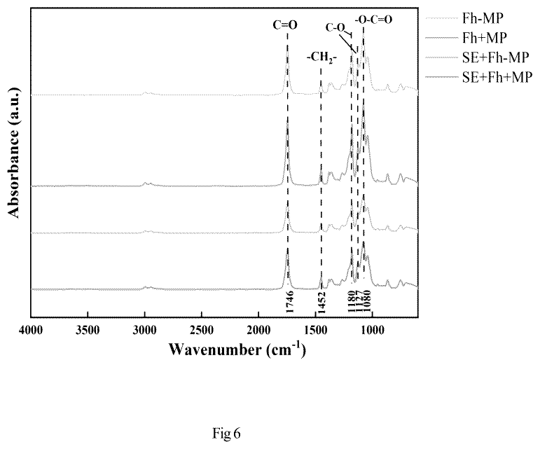

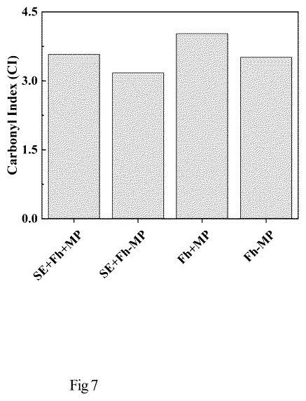

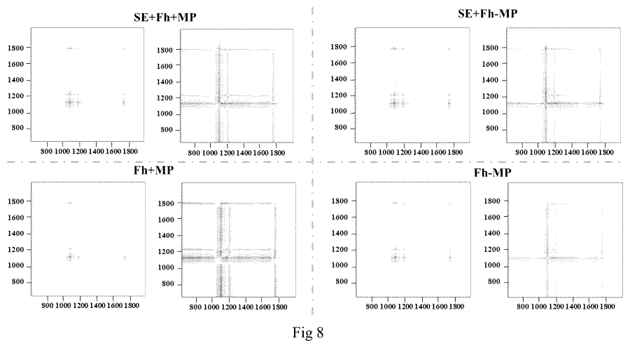

As shown in FIG. 6 and FIG. 7, a degradation degree of the functional groups of the polylactic acid microplastics of the ferrihydrite and microplastic co-precipitation group mediated by the soil microorganisms (SE+Fh−MP) is the largest, and an absorbance of a carbonyl group and the carbonyl index are significantly reduced. Meanwhile, as shown in FIG. 8, according to a Node rule, a degradation order of the functional groups of each group is found to be different. Main autopeaks are observed at 1042, 1080, 1127, 1180, and 1746 cm 1, which respectively represent C—O—C, —O—C═O, C—O, C—O, and C═O functional groups of the polylactic acid plastic. A change order of the functional groups of the different groups is as follows: for the SE+Fh+MP group, 1746>1180>1127>1080>1042 cm⁻¹; for the SE+Fh−MP group, 1080>1180>1746>1042>1127 cm⁻¹;

for the Fh+MP group, 1746>1042>1127>1180>1080 cm⁻¹; for the Fh−MP group,

1080>1746>1042>1127>1180 cm⁻¹. The results indicate that the ferrihydrite mediated by the soil microorganisms significantly promotes the degradation of the microplastics. In addition, a co-precipitation method of the ferrihydrite and the microplastics also promotes the degradation of the functional groups of the microplastics, and changes the degradation order of the functional groups of the microplastics compared with a direct addition group of the microplastics. In the SE+Fh+MP and Fh+MP groups, C═O is preferentially degraded, while in the SE+Fh−MP and Fh−MP groups, —O—C═O is preferentially degraded. The preferential degradation implies that when the ferrihydrite and the microplastics are directly mixed, free radicals generated by the ferrihydrite preferentially attack C═O, causing the degradation of the functional groups. In the ferrihydrite and microplastic co-precipitation group, the preferential degradation of —O—C═O in the microplastics causes breakage of long molecular chains of the polylactic acid into short chains.

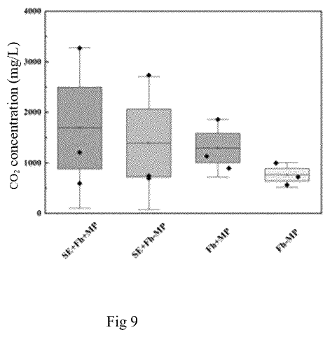

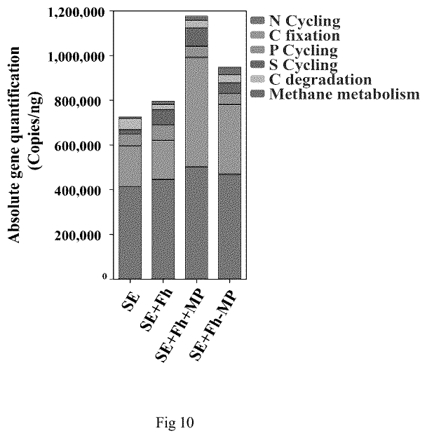

In addition, carbon dioxide is produced during a complete degradation process of the microplastics. Although carbon dioxide is also produced by microbial respiration, as shown in FIG. 9, carbon dioxide concentrations produced by the ferrihydrite and microplastic co-precipitation groups are all lower than a concentration produced by a direct interaction between the ferrihydrite and the microplastics. Besides, the direct interaction between the ferrihydrite and the microplastics significantly promotes a functional metabolism of the soil microorganisms, and an abundance of functional genes of different metabolic pathways (FIG. 10).

Through the above technical solution, the ferrihydrite mediated by the soil microorganisms in the present disclosure can effectively accelerate the degradation process of the microplastics. Especially in a natural environment, the ferrihydrite may encapsulate the microplastics during a formation process, and in the present disclosure, verification is performed that the co-precipitation of the ferrihydrite and the microplastics will further accelerate the degradation of the microplastics and produce a lower concentration of carbon dioxide. In addition, the functional genes of the microorganisms are also significantly increased due to the interaction between the ferrihydrite and the microplastics, which may in turn promote different metabolic pathways of the microorganisms in the environment. However, incomplete degradation of the microplastics may produce more microplastics or even nanoplastics, changing the environmental behavior and fate of the microplastics. Therefore, on the other hand, the present disclosure provides a theoretical basis for studying the interaction between microplastics and ferrihydrite in the environment and the environmental impact thereof.

The embodiments described above are only descriptions of modes of the present disclosure, and are not for limiting the scope of the present disclosure. Without departing from the inventive concept of the present disclosure, various variations and improvements made to the technical solutions of the present disclosure by a person of ordinary skill in the art should all fall within the scope of protection determined by the claims of the present disclosure.

1. A degradation method for microplastics in soil, comprising the following steps:
(1) extracting soil microorganisms: mixing sterile water with soil at a ratio of 2.5:1, mixing on a shaker, and standing to obtain a supernatant containing the soil microorganisms;
(2) synthesizing ferrihydrite co-precipitated with PLA MPs: dissolving 40 g of Fe(NO3)3·9·2O in 500 mL of deionized water; adding 4 g of polylactic acid microplastics, and then adding 310 mL of 1 M KOH to adjust a pH; vigorously stirring for 1 hour using a magnetic stirrer, and then performing centrifugation; after discarding a supernatant, repeatedly washing an obtained colloid 5 times with the deionized water; drying the colloid in a freeze dryer for 24 h; and storing the colloid at −20° C. for later use;
(3) performing phosphorus adhesion on the ferrihydrite: adding 1.2 g of the ferrihydrite to 500 mL of 20 mM K2HPO4, adjusting a pH to 6, incubating for 48 hours, and then freeze-drying to obtain a product; wherein incubation conditions for the incubating are 28° C. and 150 r/min; and
(4) culturing the ferrihydrite co-precipitated with PLA MPs after the phosphorus adhesion in the supernatant containing the soil microorganisms to degrade microplastic particles; wherein culture conditions for the culturing are 28° C., 150 rpm/min, and incubation in the dark for 30 days.

2. The method according to claim 1, wherein mixing conditions on the shaker in step (1) are 150 rpm/min and 30 min.

3. The method according to claim 1, wherein a standing time in step (1) is 6 h.

4. The method according to claim 1, wherein centrifugation conditions in step (2) are 12000 rpm and 12 minutes.

5. The method according to claim 1, wherein a range of the pH adjustment in step (2) is pH 7.4-7.6.
